(19) United States
(12) Patent Application Publication
(10) Pub. No.: US 2026/0051147 A1
(43) Pub. Date: Feb. 19, 2026

(54) SYSTEMS AND METHODS FOR AUTOMATED IMAGE ANALYSIS

(71) Applicant: A.I NEURAY LABS LTD., Rosh Haayin (IL)

(72) Inventors: Yotam NITZAN, Rosh Haayin (IL); Alon NITZAN, Rosh Haayin (IL)

(73) Assignee: A.I NEURAY LABS LTD., Rosh Haayin (IL)

(21) Appl. No.: 19/303,690

(22) Filed: Aug. 19, 2025

Related U.S. Application Data
(60) Provisional application No. 63/684,633, filed on Aug. 19, 2024.

(51) Int. Cl. G06V 10/74; G06V 10/40; G06V 10/774; G06V 10/82; G06V 40/10

(52) U.S. Cl. CPC G06V 10/761; G06V 10/40; G06V 10/774; G06V 10/82; G06V 40/10

(57) ABSTRACT

A method for automatically identifying elements in a scene, including obtaining first data relating to at least one first scene possibly including at least one element of interest, obtaining second data different from the first data and relating to a second scene including the at least one element of interest, processing, by a first neural network, at least some of the first data to automatically extract at least one first feature representing at least a part of the at least one first scene, processing, by a second neural network, at least some of the second data to automatically extract at least one second feature representing the element of interest, finding a difference between the at least one first feature and the at least one second feature, ascertaining whether or not the at least one element of interest is present in the at least one first scene, based on the difference and providing a human-sensible output indicative of whether or not the at least one element of interest is present in the at least one first scene.

### RELATED APPLICATIONS

Reference is hereby made to U.S. Provisional Patent Application No. 63/684,633, entitled ‘SYSTEMS AND METHODS FOR AUTOMATED IMAGE ANALYSIS’, filed Aug. 19, 2024, the disclosure of which is hereby incorporated by reference and priority of which is hereby claimed pursuant to 37 CFR 1.78(a) (4) and (5)(i).

### FIELD OF THE INVENTION

The present invention relates generally to data analysis and more particularly to automated image analysis based on machine learning.

### BACKGROUND OF THE INVENTION

Various types of systems and methods for automated image analysis based on machine learning, are known in the art.

### SUMMARY OF THE INVENTION

The present invention seeks to provide novel systems and methods for automated analysis of both single and multi-modality images, based on employing machine learning.

There is thus provided in accordance with a preferred embodiment of the present invention a method for automatically identifying elements in a scene, including obtaining first data relating to at least one first scene possibly including at least one element of interest, obtaining second data different from the first data and relating to a second scene including the at least one element of interest, processing, by a first neural network, at least some of the first data to automatically extract at least one first feature representing at least a part of the at least one first scene, processing, by a second neural network, at least some of the second data to automatically extract at least one second feature representing the element of interest, finding a difference between the at least one first feature and the at least one second feature, ascertaining whether or not the at least one element of interest is present in the at least one first scene, based on the difference and providing a human-sensible output indicative of whether or not the at least one element of interest is present in the at least one first scene.

Preferably, the method also includes training the first and second neural networks, the training including providing first training data of a same data type as the first data to the first neural network and second training data of a same type as the second data to the second neural network, the first and second training data being mutually paired into data pairs: within each the data pair, the first training data and second training data relating to a same element of interest having a common characteristic, between different ones of the data pairs, the first training data and second training data not relating to the same element of interest having the common characteristic, processing the first training data by the first neural network to extract at least one first training feature from the first training data in each the data pair, processing the second training data by the second neural network to extract at least one second training feature from the second training data in each the data pair, for at least some of the first and second training data, within the each data pair, finding an intra-data pair difference between the at least one first training feature and the at least one second training feature, the first and second training features representing the element of interest having the common characteristic within the each data pair, between the different ones of the data pairs, finding an inter-data pair difference between the at least one first training feature and the at least one second training feature, the first and second training features not representing the same element of interest having the common characteristic between the different ones of the data pairs and iteratively optimizing weights of the first and second neural networks based on minimizing the intra-data pair difference and maximizing the inter-data pair difference.

In accordance with a preferred embodiment of the present invention, between the different ones of the data pairs, the first training data and the second training data do not relate to a same element of interest.

Additionally or alternatively, between the different ones of the data pairs, the first training data and the second training data relate to the same element of interest but not having the common characteristic.

Preferably, the common characteristic includes at least one of time, pose, motion, size, velocity and location.

Preferably, the at least one element of interest includes at least one of a human being and an inanimate item.

Preferably, the first data and the second data include data of a same modality.

Preferably, the first data is acquired by a first imaging device and the second data is acquired by a second imaging device, the first data being different from the second data due to a difference in at least one of respective locations and characteristics of the first and second imaging devices.

Additionally or alternatively, the first data and the second data include mutually different modalities.

Preferably, one of the first data and second data includes camera data and another one of the first data and second data includes radar data.

Preferably, an identity of the at least one element of interest in the second scene is known, the method also including ascertaining an identity of the element of interest in the first scene to be a same identity as the identity of the element of interest in the second scene, based on the ascertaining the element of interest to be present in the first scene, the human sensible output being additionally indicative of the same identity of the element of interest in the first scene.

Preferably, the human sensible output includes a biometric output.

There is additionally provided in accordance with another preferred embodiment of the present invention a system for scene analysis including a first data acquisition device, operative to acquire first data relating to at least one first scene possibly including at least one element of interest, a second data acquisition device, operative to acquire second data different from the first data and relating to at least one second scene including the at least one element of interest and a data processor, including a first neural network operative to automatically extract, from at least some of the first data, at least one first feature representing at least a part of the at least one first scene, and a second neural network operative to automatically extract, from at least some of the second data, at least one second feature representing the element of interest, the data processor being operative to find a difference between the at least one first feature and at least one second feature, ascertain whether or not the at least one element of interest is present in the at least one first scene, based on the difference, and provide a human-sensible output indicative of whether or not the at least one element of interest is present in the at least one first scene.

Preferably, the first neural network and the second neural network are trained at least prior to operation thereof, the first neural network and the second neural network being trained by the system including the system being operative to provide first training data of a same data type as the first data to the first neural network and second training data of a same type as the second data to the second neural network, the first and second training data being mutually paired into data pairs, within each the data pair, the first training data and second training data relating to a same element of interest having a common characteristic, between different ones of the data pairs, the first training data and second training data not relating to the same element of interest having the common characteristic, process the first training data by the first neural network to extract at least one first training feature from the first training data in each the data pair, process the second training data by the second neural network to extract at least one second training feature from the second training data in each the data pair, for at least some of the first and second training data within the each data pair, find an intra-data pair difference between the at least one first training feature and the at least one second training feature, the first and second training features representing the element of interest having the common characteristic within the each data pair, between the different ones of the data pairs, find an inter-data pair difference between the at least one first training feature and the at least one second training feature, the first and second training features not representing the same element of interest having the common characteristic between the different ones of the data pairs, and iteratively optimize weights of the first and second neural networks based on minimizing the intra-data pair difference and maximizing the inter-data pair difference.

In accordance with a preferred embodiment of the system of the present invention, the first data and the second data include data of a same modality.

Preferably, the first data is different from the second data due to a difference in at least one of respective locations and characteristics of the first data acquisition device and the second data acquisition device.

Additionally or alternatively, the first data and the second data include mutually different modalities.

Preferably, one of the first data and second data includes camera data and another one of the first data and second data includes radar data.

Preferably, the human sensible output includes a biometric output.

There is further provided in accordance with yet another preferred embodiment of the present invention a method for automatically identifying elements in a scene, including obtaining first data relating to at least one first scene possibly including at least one element of interest, obtaining second data different from the first data and relating to a second scene including the at least one element of interest, processing, by a first neural network, at least some of the first data to automatically extract at least one first feature representing at least a part of the at least one first scene, processing, by a second neural network, at least some of the second data to automatically extract at least one second feature representing the element of interest, finding a difference between the at least one first feature and at least one second feature, ascertaining whether or not the at least one element of interest is present in the at least one first scene, based on the difference and automatically providing feedback control to at least one related system based on the ascertaining.

### BRIEF DESCRIPTION OF THE DRAWINGS

The present invention will be understood and appreciated more fully based on the following detailed description taken in conjunction with the drawings, in which:

FIG. 1 is a simplified block-diagram illustration of a machine learning system for image analysis, operative in an inference mode, constructed and operative in accordance with a preferred embodiment of the present invention;

FIGS. 2A and 2B are simplified block-diagram illustrations of a machine learning system of the type shown in FIG. 1, operative in a training mode, in respective first and second instances, constructed and operative in accordance with a preferred embodiment of the present invention;

FIG. 3 is a simplified block diagram illustration of a preferred implementation of a machine learning system of the type shown in FIGS. 2A and 2B operative in a training mode;

FIGS. 4A and 4B are simplified block-diagram illustrations of a machine learning system for image analysis, operative in a training mode, in respective first and second instances, constructed and operative in accordance with another preferred embodiment of the present invention;

FIG. 5 is a simplified block-diagram illustration of a machine learning system for image analysis, of the type shown in FIGS. 2A and 2B or 4A and 4B, operative in an inference mode, constructed and operative in accordance with another preferred embodiment of the present invention;

FIG. 6 is a highly simplified block diagram illustration of a method for image analysis based on machine learning, in accordance with a preferred embodiment of the present invention;

FIG. 7 is a simplified block-diagram illustration of a machine learning system for image analysis, operative in an inference mode, constructed and operative in accordance with another preferred embodiment of the present invention;

FIG. 8 is a simplified block-diagram illustration of a machine learning system for image analysis, operative in an inference mode, constructed and operative in accordance with a further preferred embodiment of the present invention; and

FIGS. 9A and 9B are simplified block diagram illustrations of a machine learning system for image analysis, operative in respective inference and training modes, constructed and operative in accordance with yet another preferred embodiment of the present invention.

### DETAILED DESCRIPTION OF PREFERRED EMBODIMENTS

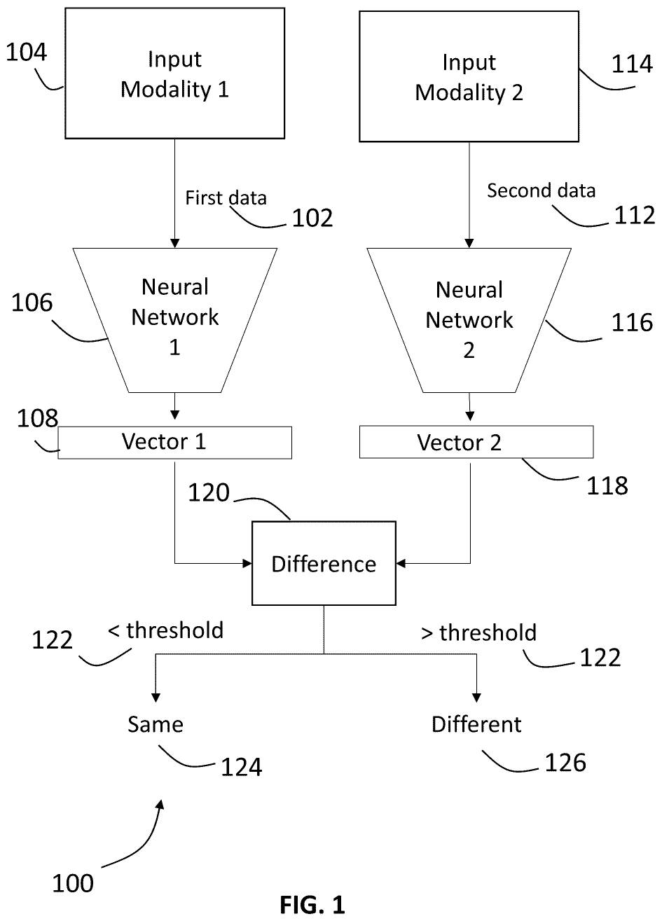

Reference is now made to FIG. 1, which is a simplified block-diagram illustration of a machine learning system for image analysis, operative in an inference mode, constructed and operative in accordance with a preferred embodiment of the present invention.

As seen in FIG. 1, there is preferably provided a machine learning system 100 for automated image analysis. System 100 preferably is provided with first data 102 acquired using a first input modality 104. In a preferred embodiment of the present invention, first input modality 104 is a first imaging modality and first data 102 is image data. For example, the first input modality 104 may be radar and first data 102 may be radar data. In other embodiments of the present invention, first data 102 may be other type(s) of image data acquired by other imaging modalities, such as camera, ultrasound, radiation-based or other image acquisition modalities. Image data comprising first data 102 may be still image data and/or video data. In still further embodiments of the present invention, first data 102 may comprise data other than image data, such as audio or textual data.

First data 102 relates to at least one first scene possibly including at least one element of interest. First data 102 may relate to a single scene possibly including at least one element of interest. Alternatively, first data 102 may relate to a plurality of scenes, each scene of the plurality of scenes possibly including the at least one element of interest. By way of example, the at least one element of interest may be a person, may be a group of people, and/or may be one or more inanimate items of interest to a user of system 100.

First data 102 may or may not include data relating to the at least one element of interest possibly present in the first scene. In one possible example, the at least one element of interest may not be present in the first scene. As a result, first data 102 does not include data relating to the at least one element of interest. In another possible example, the at least one element of interest may be present in the first scene and first data 102 thus includes data relating to the at least one element of interest. It is a function of system 100 to automatically ascertain or infer whether the at least one element of interest is present in the first scene, based on employing machine learning to analyze the first data 102.

First data 102 is preferably provided to and processed by a first machine learning network 106. By way of example, the first machine learning network 106 may be a first neural network 106. Other examples of machine learning networks are also possible, however, as will be apparent to those skilled in the art, including, by way of example only, Decision Trees, Support-Vector Machines, Genetic Algorithms, and others.

First machine learning network 106 is preferably operative to automatically extract, from first data 102, at least one first feature 108 representing at least a part of the at least one first scene to which first data 102 relates. In one embodiment, the at least one first feature 108 may be a first vector 108 extracted from first data 102. First vector 108 may represent some or all of first data 102. First vector 108 may represent some or all of the at least one first scene to which first data 102 relates.

System 100 is preferably operative to find a difference between the at least one first feature, such as first feature 108, extracted from first data 102 and at least one second feature of second data 112. Second data 112 is different from the first data 102 and relates to a second scene including the at least one element of interest possibly present in the at least one first scene to which first data 102 relates. Second data 112 is preferably acquired by a second input modality 114. The second scene to which the second data 112 relates may or may not be the same scene as the first scene to which the first data 102 relates.

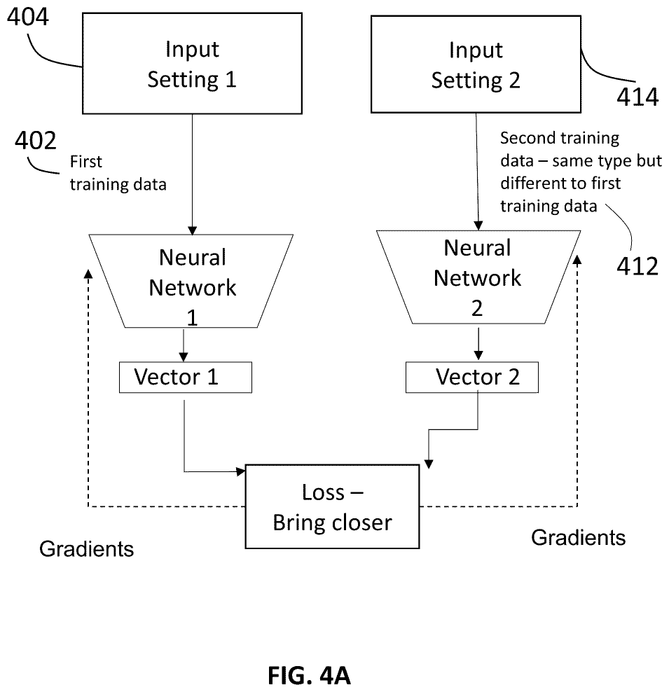

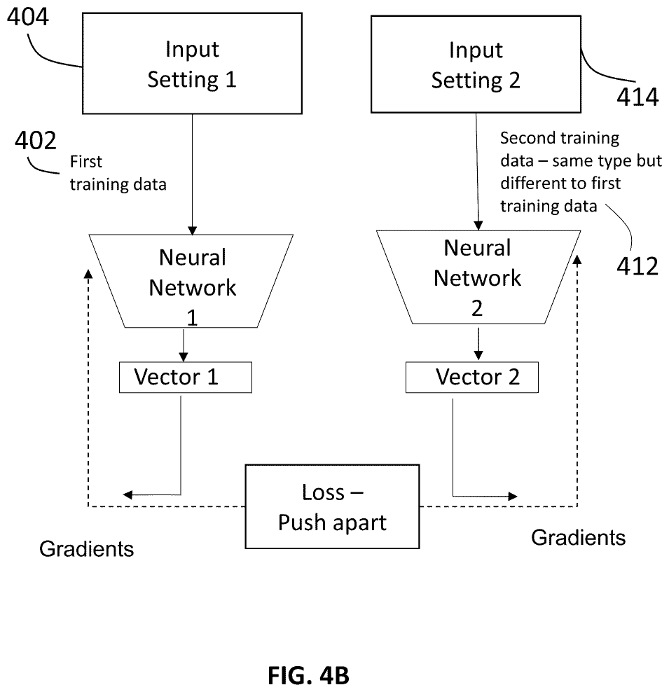

In a preferred embodiment of the present invention, second input modality 114 is a second imaging modality different from first input modality 104 and second data 112 is image data of a different type to first data 102. For example, in the case that the first input modality 104 is radar, the second input modality 114 may be camera and second data 112 may be camera data. In other embodiments of the present invention, second data 112 may be other type(s) of image data acquired by other imaging modalities, such as ultrasound, radiation-based or other images different than first data 102. Image data comprising second data 112 may be still image data and/or video data. In still further embodiments of the present invention, second data 112 may comprise data other than image data, such as audio or textual data. In yet further embodiments of the present invention, as further detailed with respect to FIGS. 4A and 4B, second data 112 may comprise the same type of data as first data 102 but captured or acquired in a different manner, such that first data 102 is nonetheless different than second data 112 despite first and second data 102 and 112 being of a same type, for example, both radar images or both camera images.

System 100 preferably includes a second machine learning network 116 preferably operative to automatically extract, from second data 112, at least one second feature 118 representing at least a part of the at least one second scene to which second data 112 relates. In one embodiment, the at least one second feature 118 may be a second vector 118 extracted from second data 112. Second vector 118 may represent some or all of second data 112. Second vector 118 may represent some or all of the at least one second scene to which second data 112 relates. Second feature 118 at least represents the element of interest included in the second scene to which second data 112 relates.

In order to ascertain whether or not the at least one element of interest is present in the at least one first scene, system 100 is preferably operative to automatically find a difference 120 (distance) between the at least one first feature, such as first vector 108, extracted from first data 102 and the at least one second feature, such as second vector 118, extracted from second data 112. System 100 may find the difference 120 (distance) between first feature 108 and second feature 118 by way of any suitable algorithm as may be known in the art. For example, system 100 may find a distance between first vector 108 and second vector 118 using Cosine Distance.

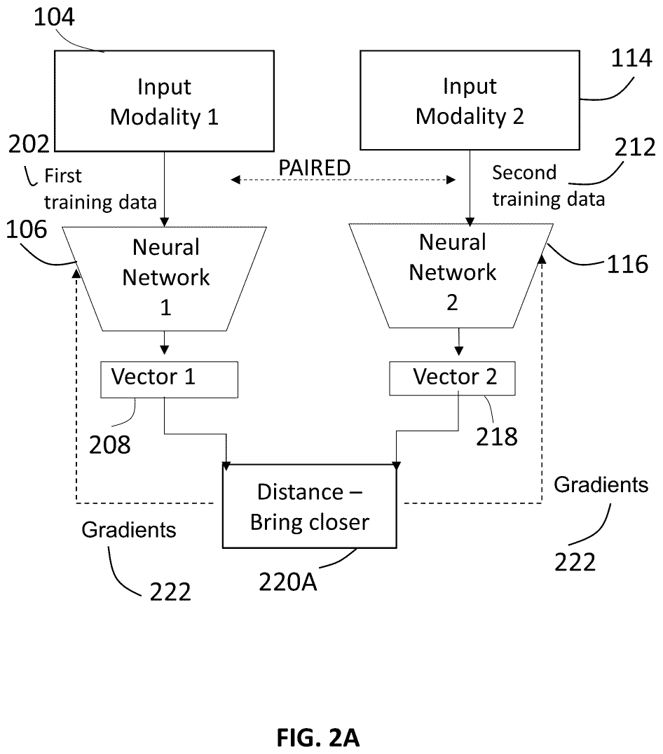

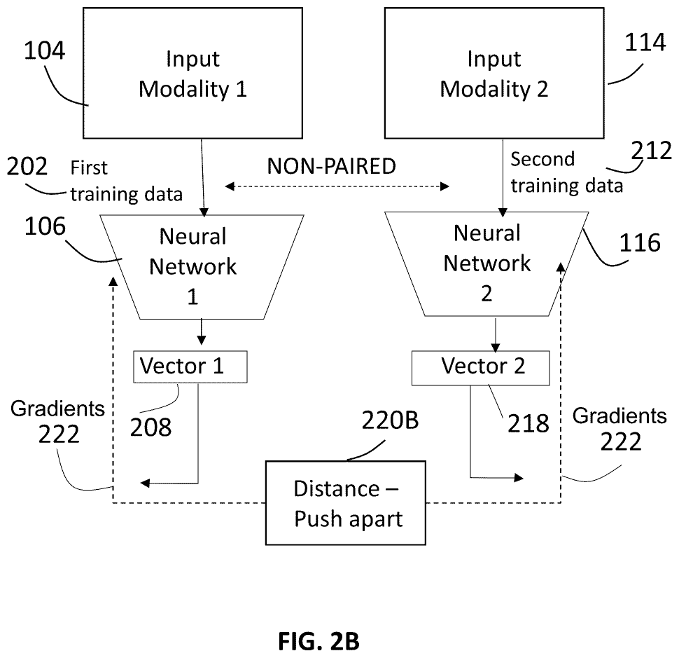

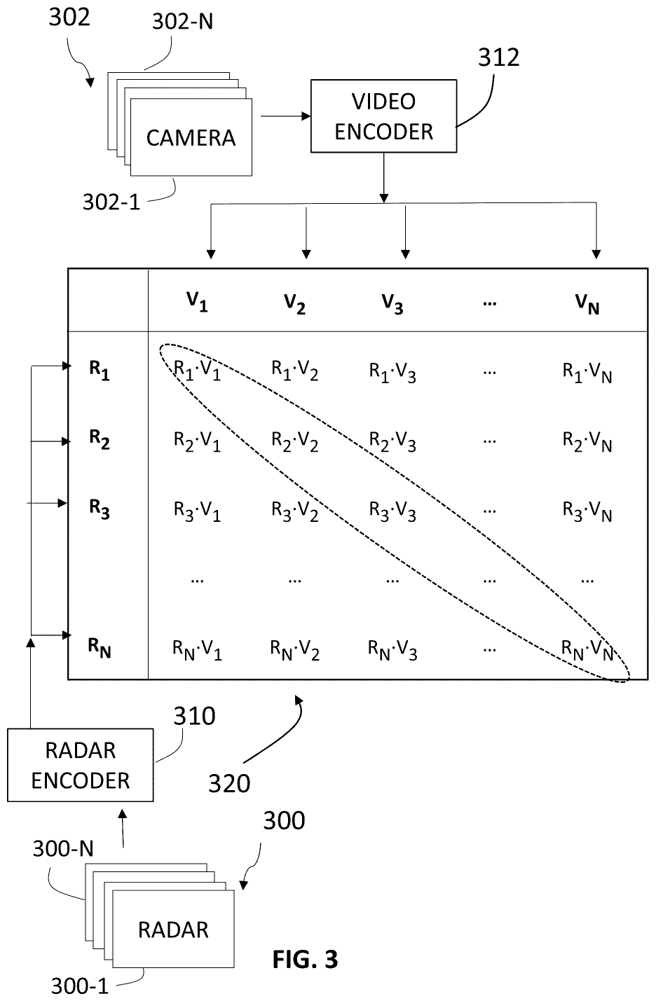

System 100 may be operative to ascertain whether or not the at least one element of interest is present in the at least one first scene based on whether the difference 120 between first and second features 108 and 118 is above or below a given threshold 122. For example, if the difference 120 is below threshold 122, first and second features 108 and 118 may be considered to represent the same element of interest and thus the at least one element of interest may be considered to indeed be present in the at least one first scene, as shown at an output 124. Conversely, if the difference 120 is greater than or equal to threshold 122, first and second features 108 and 118 may be considered not to represent the same element of interest and thus the at least one element of interest may be considered to be absent from the at least one first scene, as shown at an output 126. Threshold 122 may be a predetermined fixed threshold or may be found during training of system 100, as is further detailed henceforth with respect to FIGS. 2A-3.

In one possible embodiment of the present invention, one or both of first and second features 108 and 118 may comprise sub-features. For example, in the case that first data 102 is radar data relating to a person of interest in a particular pose, first features 108 may includes a plurality of sub-features corresponding to particular aspects of the pose of the person, such as the location and angle of various key points along the person's body. Similarly, in the case that second data 112 is camera data relating to a person of interest in a particular pose, second features 118 may include a plurality of sub-features corresponding to particular aspects of the pose of the person, such as the location and angle of various key points along the person's body.

In this case, system 100 may be operative to ascertain whether or not the at least one element of interest, such as the person in a given pose, is present in the at least one first scene based on finding a difference between at least some of the first sub-features of first features 108 and the second sub-features of second features 118. For example, system 100 may be operative to find a cumulative difference between the first and second sub-features with respect to a given threshold, or otherwise compare the first and second sub-features.

Outputs 124 and 126 may be provided in the form of a human-sensible output, indicative of whether or not the at least one element of interest is present in the at least one first scene. Output 124 and 126 may be indicative of whether first data 102 and second data 112 represent the same element of interest (output 124) or different elements (output 126). For example, outputs 124 and 126 may be in the form of a notification to a user of system 100. Additionally or alternatively, outputs 124 and 126 may be used to automatically provide feedback control to at least another system related to or cooperative with system 100, for example, to an additional image acquisition system or security system. For example, the feedback control may trigger the additional image acquisition system to acquire additional images of the scene and/or may trigger activation of security measures by a security system in operative communication with system 100.

In one possible embodiment of system 100, an identity of the at least one element of interest in the second scene may be known, such that system 100 may additionally be operative to ascertain an identity of the element of interest in the first scene to be the same as the identity of the element of interest in the second scene, based on ascertaining the element of interest to be present in the first scene. In such a case, output 124 may comprise a biometric output.

It is understood that first and second networks 106 and 116 are described hereinabove as configured to operate, and operating, in an inference mode. In an inference mode, the first and second networks 106 and 116 are automatically operative to extract features 108 and 118 respectively from first and second data 102 and 112, based on which features a comparison may be made between first and second data 102 and 112 in order to ascertain whether first and second data 102 and 112 mutually relate to a same element of interest. Prior to, and possibly also concurrently with operation in inference mode, first and second networks 106 and 116 are trained in order to be accurately configured to automatically extract relevant features from first and second data 102 and 112, based on which a meaningful comparison between the data may be performed. A possible training mode of system 100 is now described with reference to FIGS. 2A, 2B and 3.

As seen in FIGS. 2A and 2B, during training, first network 106 is provided with first training data 202. First training data 202 is preferably of a same data type as the first data 102. By way of example, first training data 202 may be a multiplicity of radar images R1-RN, as shown in FIG. 3. Second network 116 is provided with second training data 212. Second training data 212 is preferably of a same data type as the second data 112. By way of example, second training data 212 may be a multiplicity of camera video images, V1-VN, as shown in FIG. 3.

The first and second training data 202 and 212 are preferably mutually paired into data pairs upon provision thereof to system 100. Within each data pair, the first training data 202 and the second training data 212 relate to a same element of interest having a common characteristic, as shown in the training instance illustrated in FIG. 2A. Here, the first training data 202 and the second training data 212 are paired and relate to the same element of interest having a common characteristic. For example, the paired first training data 202 and the second training data 212 in FIG. 2A may relate to a same element of interest, the same element of interest captured at a same time frame, a same element of interest performing a same motion, a same element of interest in a same pose, or other possible examples. For example, the element of interest may be a person, an animal or an inanimate object.

Between different ones of the data pairs, the first training data 202 and second training data 212 do not relate to the same element of interest having the common characteristic, as shown in the training instance illustrated in FIG. 2B. Here, the first training data 202 and the second training data 212 do not belong to a same data pair and do not relate to the same element of interest having the common characteristic. For example, the non-paired first training data 202 and second training data 212 in FIG. 2B may not relate to a same element of interest. By way of example, the first training data 202 in FIG. 2B may relate to a first person and the second training data 212 in FIG. 2B may relate to a second person, different from the first person. Further by way of example, the non-paired first training data 202 and second training data 212 in FIG. 2B may indeed relate to a same element of interest but not having the common mutual characteristic, for example the same interest of interest captured at mutually different time frames, the same element of interest performing a mutually different motion, the same element of interest in mutually different poses or other possible examples. In this case, for example, the first training data 202 in FIG. 2B may relate to a first person at a first time and/or in a first pose and the second training data 212 in FIG. 2B may relate to the same first person but at a second time and/or in a second pose.

During training in both of the instances shown in FIGS. 2A and 2B, the first training data 202 is processed by the first neural network 106 to extract at least one first training feature 208 from the first training data 202 and the second training data 212 is processed by the second neural network 116 to extract at least one second training feature 218 from the second training data 212. By way of example, first and second training features 208 and 218 may be vectors.

As shown in the instance illustrated in FIG. 2A, for at least some the first and second training data 202 and 212, within each data pair, an intra-data pair difference 220A between the at least one first training feature 208 and the at least one second training feature 218 is found, the first and second training features 208 and 218 representing the element of interest having the common characteristic within each data pair.

As shown in the instance illustrated in FIG. 2B, for at least some the first and second training data 202 and 212, between the different ones of the data pairs, an inter-data pair difference 220B is found between the at least one first training feature 208 and the at least one second training feature 218, the first and second training features 208 and 218 not representing the same element of interest having the common characteristic between different ones of the data pairs.

The weights of the first and second neural networks 106 and 116 are then preferably iteratively optimized based on minimizing the intra-data pair difference 220A and maximizing the inter-data pair difference 220B. As shown in the instance illustrated in FIG. 2A, the gradients 222 of first and second neural networks 106 and 116 are adjusted, preferably iteratively, in order to bring first and second training features 208 and 218 as close together or as similar as possible. Conversely, as shown in the instance illustrated in FIG. 2B, the gradients 222 of first and second neural networks 106 and 116 are adjusted, preferably iteratively, in order to bring first and second training features 208 and 218 as far apart, or as dissimilar, as possible.

It is appreciated that the two instances of FIGS. 2A and 2B are shown and described as two disparate instances for the purpose of clarity of explanation of the training involved in each instance. However, in practice, neural networks 106 and 116 undergo the training of the instances of FIGS. 2A and 2B in an integrated, concurrent way, as the neural networks are concurrently iteratively optimized based on comparing data within and between the data pairs provided thereto.

It is further appreciated that although reference is made to the optimization of the gradients 222 of first and second neural networks 106 and 116, this is to be understood as simply one example of an optimization of a machine learning network suitable for carrying out the automatic feature extraction functionality described herein. Other examples are also possible.

Turning now to FIG. 3, a particular example of training of a system of a type such as system 100, in the context of camera and radar imaging, is shown. As mentioned hereinabove, R1-RN refer to vectors 1-N extracted from corresponding radar training data 300. For example, R1 may refer to a first vector extracted from a first radar image 300-1 and so forth. V1-VN refer to vectors 1-N extracted from corresponding camera video data 302. For example, V1 may refer to a first vector extracted from a first camera image 302-1 and so forth. Vectors R1-RN may be extracted by a radar encoder 310, which is one preferred embodiment of first neural network 106. Vectors V1-VN may be extracted by a video encoder 312, which is one preferred embodiment of second neural network 116. R1-RN may be a preferred embodiment of first vectors 208. V1-VN may be a preferred embodiment of second vectors 218.

By way of example, vectors R1-RN and V1-VN may be paired sequentially, such that radar image R1 relates to (includes therein) a same element of interest having a common characteristic with that included in or captured by video image V1, radar image R2 relates to (includes therein) a same element of interest having a common characteristic with that included in or captured by video image V2 and so forth. For example, in each pair of camera and radar images, the camera and radar images of the given pair may show (include or capture) a same person, whereas between different ones of pairs of camera and radar images, the camera and radar images may not show (include or capture) a same person. Further by way of example, in each pair of camera and radar images, the camera and radar images in the given pair may show a same person in the same pose, whereas between different ones of pairs of camera and radar images, the camera and radar images may show a same person but in mutually different poses and/or at mutually different times and so forth.

Radar encoder 310 and video encoder 312 may be iteratively optimized to minimize a difference between paired radar and camera data (e.g. minimize a difference between R1 and V1, between R2 and V2 etc.) and to maximize a difference between the different pairs of radar and camera data (e.g. maximize a difference between R1 and V2, between R1 and V3 etc.). Referring to a matrix of differences 320 shown in FIG. 3, differences between extracted vectors along the diagonal of the matrix, representing intra-pair differences, are minimized during training, preferably concurrently with differences along the non-diagonal members of the matrix, representing inter-pair differences, being maximized. It is appreciated that the radar and camera encoders 310 and 312 are thus preferably trained concurrently with respect to one another, as each encoder is taught to give as similar as possible a representation to the other encoder in the case of paired data (e.g. same person or same item) and as different as possible a representation to the other encoder in the case of non-paired data (e.g. not the same person or not the same item).

It is understood that the training regime of FIGS. 2A-3 thus may be used to teach machine learning networks of system 100 to automatically extract highly mutually similar features from different images of a same element of interest, despite the different images containing mutually different data, for example due to having been acquired by mutually different imaging modalities. Following training, during operation in inference mode, as shown in FIG. 1, system 100 is thus capable of receiving new data and automatically identifying whether an element of interest is or is not present in the new data based on comparing features extracted from the new data to features extracted from other data in which the element of interest is known to be represented.

This may be highly advantageous in a range of applications, such as security, medical, smart home, or advertising. For example, in security applications, a radar image of a scene may be automatically analyzed by system 100 to detect the possible presence of an individual of interest, based on comparison to a camera image showing the same individual of interest. Further by way of example, in certain medical applications the use of camera imaging may violate human privacy. However, radar imaging may be used in order to identify an individual of interest, such as in the context of medical device use, based on a comparison to a camera image showing the same individual of interest in a non-sensitive setting.

It is appreciated that the first data 102 and second data 112 are not necessarily acquired at the same or similar times. For example, in security applications, first data 102 may comprise radar images of a scene continuously acquired in real time during the monitoring of a premises. First data 102 comprising the radar image of the scene may be provided to system 100 and analyzed to detect the possible presence of a particular individual of interest in the premises, based on comparison to a camera image of the individual of interest, the camera image comprising second data 112. The camera image 112 may have been acquired at an earlier time compared to the time at which first data 102 is acquired. In alternative embodiments of the present invention, first and second data 101 and 112 may be acquired simultaneously or at least partially simultaneously.

The present invention may find particular utility in analyzing data across public and private scenes or locations. By way of example, the first scene which possibly includes at least one element of interest may be a private scene or location, in which it may be undesirable to install cameras. For example, the first scene may be a bedroom or other private location within a home. The second scene, which includes the at least one element of interest, may be a public scene or location, in which it may be acceptable to install cameras. For example, the second scene may be a path leading to a house or an area within a house in which less privacy is required than in the first scene, such as a living room or kitchen. Camera data may be acquired for the second scene and radar data acquired for the first scene, which different types of data may be automatically analyzed by the system and method of the present invention. It is appreciated that the converse is also possible, wherein the first scene may be a public scene, for which camera data is acquired, and the second scene a private scene, for which radar data is acquired.

The present invention thus may be particularly advantageous in home-monitoring setups, such as for the elderly or otherwise vulnerable, in which privacy may be maintained notwithstanding automatic monitoring and/or identification of individuals.

The training described hereinabove with reference to FIGS. 2A-3 is described in the context of first and second training data comprising training data of two different respective modalities, such as camera and radar data. However, it is appreciated that although this is one preferred embodiment of the present invention, in other embodiments of the present invention, first and second training data 202 and 212 and first and second data 102 and 112 may be data of a same modality, but nonetheless having differences therebetween. For example, first and second data 102 and 112 and first and second training data 202 and 212 may be of a same modality, but acquired by different models or makes of data acquisition devices, or by the same or different data acquisition devices mounted in mutually different locations or having mutually different settings.

A training set-up similar to FIGS. 2A and 2B, for such a single-modality embodiment, is shown in FIGS. 4A and 4B. In FIGS. 4A and 4B, first training data 402 may be acquired using a first input setting 404 and second training data 412 may be acquired using a second input setting 414, wherein first and second input settings 404 and 414 correspond to a same type of data acquisition modality. Nonetheless, differences may exist between first training data 402 and second training data 412 due to differences between first input setting 404 and second input setting 414.

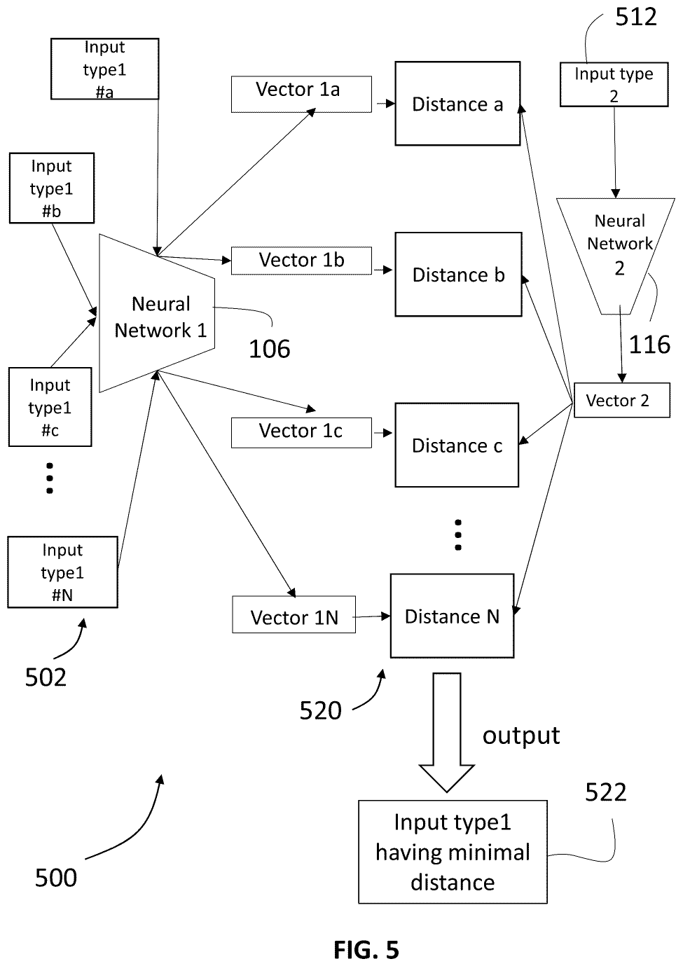

Reference is now made to FIG. 5, which is a simplified block-diagram illustration of a machine learning system for image analysis, of the type shown in FIGS. 2A and 2B or 4A and 4B, operative in an inference mode, constructed and operative in accordance with another preferred embodiment of the present invention.

As seen in FIG. 5, a machine learning system 500 of the present invention may operate in a one-to-many inference mode alternatively or in addition to the one-to-one inference mode shown in FIG. 1. First data 202 is shown to be embodied as a multiplicity of type 1 data inputs 1-N 502. Type 1 data inputs 1-N 502 may be provided to first neural network 106. First neural network 106 may be operative to process type 1 data inputs 1-N 502 and to automatically extract corresponding vectors 1A-1N. Second data 212 is shown to be embodied as a type 2 data input 512. Type 2 data input 512 may be provided to second neural network 116. Second neural network 116 may be operative to process type 2 data input 512 and to automatically extract a corresponding vector 2. Type 1 data inputs 1-N 502 may be of a same modality as type 2 data input 512, corresponding to the training regime of FIGS. 4A and 4B, or of a different modality to type 2 data input 512, corresponding to the training regimes of FIGS. 2A-3.

System 500 may be configured to find, and preferably finds, a multiplicity of distances 520 between each of the vectors 1A-1N and vector 2. System 500 is configured to output, and preferably outputs, 522 the particular input type 1 having a corresponding vector with minimal distance from vector 2. The particular input type 1 having a corresponding vector with minimal distance from vector 2 may be considered to correspond to the input type 1 showing a same element of interest as input type 2 having a same characteristic.

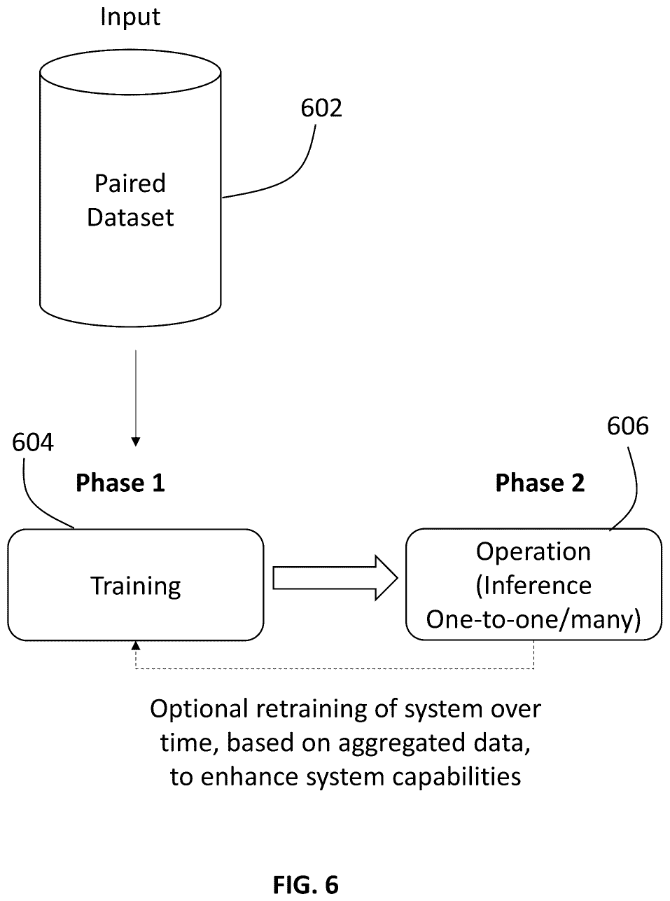

Reference is now made to FIG. 6, which is a highly simplified block diagram illustration of a method for image analysis based on machine learning, in accordance with a preferred embodiment of the present invention.

As seen in FIG. 6, a paired data set 602 is provided as input to a machine-learning system of the present invention. The machine learning system may be, for example, machine learning system 100 of FIG. 1 or the machine learning system 500 of FIG. 5. In a first phase, indicated by a reference number 604, the machine learning system undergoes training. The training may be in accordance with any of the training embodiments shown in FIGS. 2A-4B. In a second phase, indicated by a reference number 606, the machine learning system operates in an inference mode. The inference mode may be a one-to-one inference mode, as shown in FIG. 1, or a many-to-one inference mode as shown in FIG. 5.

It is appreciated that the first phase may not conclude upon initiation of the second phase. For example, the first training phase may be continued until first and second neural networks 106 and 116 are considered to be sufficiently accurately trained. At this point, the second inference phase may be initiated. However, data from the second inference phase may be fed back to the first training stage and used to further dynamically refine the training of first and second neural networks 106 and 116.

Furthermore, in some embodiments of the present invention, data accumulated during operation of first and second neural networks 106 and 116 may be fed back to the first training stage and used to further train first and second neural networks 106 and 116 in order to add or change inference capabilities thereof. The data, accumulated over time, may be used as training data for a second round of training performed once the system is operational, in order to enhance or change the inference capabilities of the neural networks 106 and 116. The data used for the second round of training may include the inference, or output, of system 100 with respect to that data. Additionally or alternatively, the data used for the second round of training may not include the inference, or output, of system 100 but rather simply include the data itself, as input to system 100 during operation.

By way of example, the data accumulated over time during operation may be used to train the neural networks to identify additional or alternative properties of a scene. Such training may build on the initial trained network and thus may be quicker and require less data than should the neural networks be trained ‘from scratch’ for a new task.

At least some parts of the systems of the present invention may be embodied in a computer system for automatically identifying elements of interest in a scene. The computer system may include one or more processors and a program memory coupled to the one or more processors and storing executable instructions, that when executed by the one or more processors, cause the computer system to automatically perform some or all functionalities of the systems and methods of the present invention, such as the functionalities of system 100, including feature extraction of first and second features 108 and 118 by first and second networks 106 and 116, finding the difference 120 between first and second features 108 and 118 and ascertaining, based on the difference 120, whether or not the first element of interest is included in the at least one first scene.

By way of example, system 100 of FIG. 1 may include a tangible, non-transitory computer-readable medium storing executable instructions for automatically identifying elements of interest in a scene, that when executed by one or more processors of a computer system, cause the computer system to perform the methods of the present invention.

The computing system, which may include a single computing system or device or multiple computing systems or devices, may be configured to input first and second data 102 and 112 to at least one machine learning model or algorithm such as first neural network 106 and second neural network 116 to derive first and second vectors 108 and 118. The computing system may further be configured to find difference 120 between first and second vectors 108 and 118 and, based on difference 120, to output notification 124 or 126, based on using at least one machine learning model or algorithm. First neural network 106 and second neural network 116 may be stored in the computing system, for example in the one or more processors thereof.

The computing system may further be operative to train the first and second neural networks 106 and 116, as shown in FIGS. 2A-4B, and/or operate in accordance with the inference mode of FIG. 5.

In some embodiments of the present invention, some or all components of the computer system may be incorporated within one or both of the image acquisition devices by which the first data 102 and second data 112 is acquired. In other embodiments of the present invention, the computer system executing the method of the present invention is a separate component from the image acquisition devices of the present invention.

In some embodiments, following image acquisition of first and second data 102 and 112, the computer system may operate in an entirely automated manner, by one or more processors (e.g. a CPU or GPU) executing instructions stored on one or more non-transitory, computer readable storage media (e.g. a memory) to execute image analysis to automatically identify elements in a scene according to the present invention.

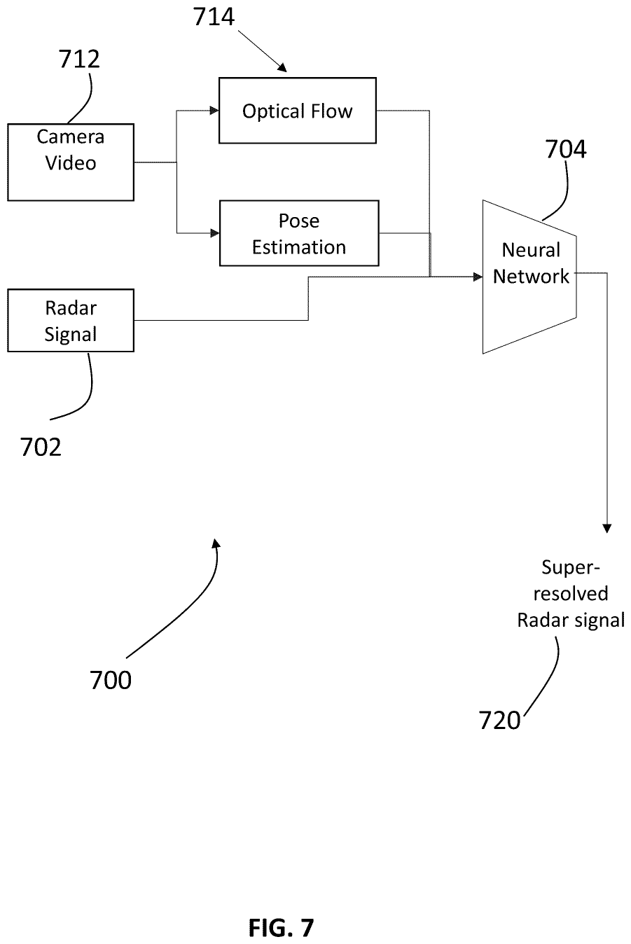

Reference is now made to FIG. 7, which is a simplified block-diagram illustration of a machine learning system for image analysis, operative in an inference mode, constructed and operative in accordance with another preferred embodiment of the present invention.

As seen in FIG. 7, there is preferably provided a machine learning system 700 for automated image analysis. System 700 preferably is provided with first data 702 acquired using a first input modality. First data 702 preferably relates to at least one first scene including at least one element of interest. For example, first data 702 may be embodied as radar signals. First data 702 is preferably processed by a first neural network 704, in order to automatically extract at least one first feature therefrom, the at least one first feature defining a representation of the element of interest. By way of example, the element of interest may be a person, more than one person and/or an inanimate item of interest.

It is understood that the at least one feature extracted, by first neural network 704, from first data 702 may lack certain information or characteristics due to limitations inherent in the first input modality by which first data 702 was acquired. It may therefore be advantageous to augment the representation of the element of interest based on first data 702 by features extracted from other data. The other data may be different from first data 702 and may include additional information not present in first data 702, but nonetheless may relate to the same element of interest to which first data 702 relates.

For this purpose, system 700 is preferably provided with second data 712. Second data 712 is different from first data 702 and relates to a second scene including the at least one element of interest. The second scene to which the second data 712 relates may or may not be the same scene as the first scene to which the first data 702 relates. The second data 712 may be of a different modality to first data 702 or may be of a same modality but nonetheless differ therefrom, for example due to differences in respective locations or characteristics of image acquisition devices by which the data are acquired. Here, by way of example, second data 712 are shown to be embodied as camera data. The representation of the element of interest based on first data 702 is preferably augmented by taking into account at least one second feature 714 of the second data 712, the at least one second feature being automatically extracted from the second data and representing the element of interest.

Here, by way of example, the at least one second feature 714 is shown to include optical flow and pose estimation information. It is appreciated, however, that the at least one second feature 714 may comprise any feature that may augment the representation of the element of interest derived based on first data 702. By way of example, the at least one second feature 714 may include a feature relating to resolution, color, background or fore-ground segmentation, motion analysis and/or pose analysis. In some embodiments, the at least one second feature 714 may be a sub-feature of the at least one first feature extracted, by first neural network 704, from first data 702.

The at least one second feature 714 may be used to enrich the representation of the element of interest obtained based on the first data 702. In one possible embodiment of the present invention, the at least one second feature 714 may be input into first neural network 704 together with first data 702, in order to enrich the representation of first data 702 extracted by first neural network 704. In another possible embodiment of the present invention, the at least one second feature 714 may be used to augment the representation of first data 702 following the output of the representation by first neural network 704. Both are also possible.

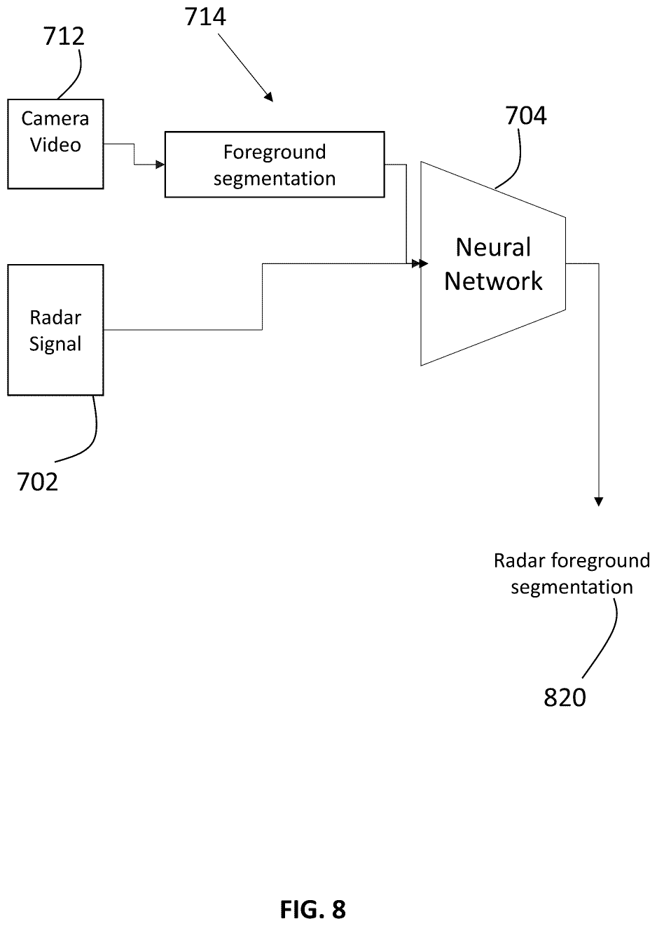

Here, by way of example, enrichment of the output of neural network 704 by the at least one second feature 714 leads to a super-resolved radar signal 720. Further by way of example, as seen in FIG. 8, in the case that at least one second feature 714 relates to foreground segmentation, enrichment of the output of neural network 704 by the at least one second feature 714 leads to a radar foreground segmented signal 820. It is appreciated that some or all of the features of the systems and methods of FIGS. 7 and 8 may be combined with any of the embodiments of FIGS. 1-6.

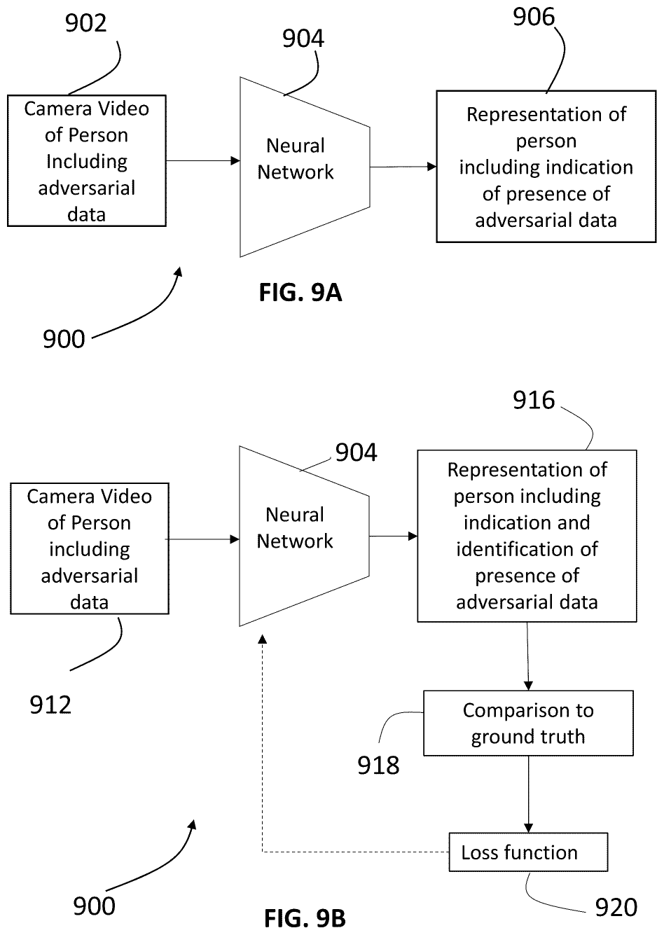

Reference is now made to FIGS. 9A and 9B, which are simplified block diagram illustrations of a machine learning system for image analysis, operative in respective inference and training modes, constructed and operative in accordance with yet another preferred embodiment of the present invention.

Turning first to FIG. 9A, a machine learning system 900 is preferably provided with first data 902. First data 902 preferably relates to a scene including an element of interest. First data may also include adversarial data. Adversarial data may refer to malicious data which obfuscates valid data relating to the element of interest in the scene. By way of example, adversarial data may include electronic warfare data or adversarial behavioral data intended to deliberately obfuscate data relating to the element of interest in the scene. Here, by way of example, first data 902 is shown to be embodied as camera video data in which the element of interest is a person.

First data 902 is preferably provided to a machine learning network, such as a neural network 904. Neural network 904 is preferably operative to process at least some of first data 902 and to automatically extract at least one feature representing the element of interest. Neural network 904 is preferably configured to extract the at least one feature representing the element of interest, notwithstanding the possible presence of adversarial data within first data 902. Here, by way of example, neural network 904 is preferably configured to extract a representation of the person of interest.

System 900 is preferably operative to provide an output indication 906 relating to the at least one feature and additionally including an indication of whether the first data 902 includes the adversarial data.

In order for neural network 904 of system 900 to be capable of extracting the at least one feature representing the element of interest, neural network 904 undergoes training prior to the implementation thereof. A possible regime for training of neural network 904 is shown in FIG. 9B. Turning now to FIG. 9B, during training neural network 904 is provided with training data 912. Training data 912 are preferably of a same type of data as first data 902. Training data 912 preferably include data relating to an element of interest as well as adversarial data. Continuing with the example of FIG. 9A, training data 912 may be camera video data including adversarial data.

Neural network 904 is preferably operative to extract at least one feature relating to the element of interest, as well as an indication of the presence of adversarial data 916. The at least one feature extracted by neural network 904 may be compared to a ground truth analysis 918 of the training data 912. A loss function 920, representing a discrepancy between the feature extraction and adversarial data identification by neural network 904 and the ground truth, may be generated and fed back to the neural network 904 in order to iteratively optimize the weights thereof. It is appreciated that some or all of the features of the systems and methods of FIGS. 9A and 9B may be combined with any of the embodiments of FIGS. 1-8.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A method for automatically identifying elements in a scene, comprising:
obtaining first data relating to at least one first scene possibly including at least one element of interest;
obtaining second data different from said first data and relating to a second scene including said at least one element of interest;
processing, by a first neural network, at least some of said first data to automatically extract at least one first feature representing at least a part of said at least one first scene;
processing, by a second neural network, at least some of said second data to automatically extract at least one second feature representing said element of interest;
finding a difference between said at least one first feature and said at least one second feature;
ascertaining whether or not said at least one element of interest is present in said at least one first scene, based on said difference; and
providing a human-sensible output indicative of whether or not said at least one element of interest is present in said at least one first scene.

2. A method according to claim 1, and also comprising training said first and second neural networks, said training comprising:
providing first training data of a same data type as said first data to said first neural network and second training data of a same type as said second data to said second neural network,
said first and second training data being mutually paired into data pairs:
within each said data pair, said first training data and second training data relating to a same element of interest having a common characteristic;
between different ones of said data pairs, said first training data and second training data not relating to said same element of interest having said common characteristic;
processing said first training data by said first neural network to extract at least one first training feature from said first training data in each said data pair;
processing said second training data by said second neural network to extract at least one second training feature from said second training data in each said data pair;
for at least some of said first and second training data:
within said each data pair, finding an intra-data pair difference between said at least one first training feature and said at least one second training feature, said first and second training features representing said element of interest having said common characteristic within said each data pair;
between said different ones of said data pairs, finding an inter-data pair difference between said at least one first training feature and said at least one second training feature, said first and second training features not representing said same element of interest having said common characteristic between said different ones of said data pairs; and
iteratively optimizing weights of said first and second neural networks based on minimizing said intra-data pair difference and maximizing said inter-data pair difference.

3. A method according to claim 2, wherein, between said different ones of said data pairs, said first training data and said second training data do not relate to a same element of interest.

4. A method according to claim 2, wherein, between said different ones of said data pairs, said first training data and said second training data relate to said same element of interest but not having said common characteristic.

5. A method according to claim 2, wherein said common characteristic comprises at least one of time, pose, motion, size, velocity and location.

6. A method according to claim 1, wherein said at least one element of interest comprises at least one of a human being and an inanimate item.

7. A method according to claim 1, wherein said first data and said second data comprise data of a same modality.

8. A method according to claim 7, wherein said first data is acquired by a first imaging device and said second data is acquired by a second imaging device, said first data being different from said second data due to a difference in at least one of respective locations and characteristics of said first and second imaging devices.

9. A method according to claim 1, wherein said first data and said second data comprise mutually different modalities.

10. A method according to claim 9, wherein one of said first data and second data comprises camera data and another one of said first data and second data comprises radar data.

11. A method according to claim 1, wherein an identity of said at least one element of interest in said second scene is known, said method also comprising:
ascertaining an identity of said element of interest in said first scene to be a same identity as said identity of said element of interest in said second scene, based on said ascertaining said element of interest to be present in said first scene,
said human sensible output being additionally indicative of said same identity of said element of interest in said first scene.

12. A method according to claim 1, wherein said human sensible output comprises a biometric output.

13. A system for scene analysis comprising:
a first data acquisition device, operative to acquire first data relating to at least one first scene possibly including at least one element of interest;
a second data acquisition device, operative to acquire second data different from said first data and relating to at least one second scene including said at least one element of interest; and
a data processor, comprising:
a first neural network operative to automatically extract, from at least some of said first data, at least one first feature representing at least a part of said at least one first scene, and
a second neural network operative to automatically extract, from at least some of said second data, at least one second feature representing said element of interest,
said data processor being operative to:
find a difference between said at least one first feature and at least one second feature,
ascertain whether or not said at least one element of interest is present in said at least one first scene, based on said difference, and
provide a human-sensible output indicative of whether or not said at least one element of interest is present in said at least one first scene.

14. A system according to claim 13, wherein said first neural network and said second neural network are trained at least prior to operation thereof, said first neural network and said second neural network being trained by said system comprising said system being operative to:
provide first training data of a same data type as said first data to said first neural network and second training data of a same type as said second data to said second neural network,
said first and second training data being mutually paired into data pairs:
within each said data pair, said first training data and second training data relating to a same element of interest having a common characteristic;
between different ones of said data pairs, said first training data and second training data not relating to said same element of interest having said common characteristic;
process said first training data by said first neural network to extract at least one first training feature from said first training data in each said data pair;
process said second training data by said second neural network to extract at least one second training feature from said second training data in each said data pair;
for at least some of said first and second training data:
within said each data pair, find an intra-data pair difference between said at least one first training feature and said at least one second training feature, said first and second training features representing said element of interest having said common characteristic within said each data pair;
between said different ones of said data pairs, find an inter-data pair difference between said at least one first training feature and said at least one second training feature, said first and second training features not representing said same element of interest having said common characteristic between said different ones of said data pairs; and
iteratively optimize weights of said first and second neural networks based on minimizing said intra-data pair difference and maximizing said inter-data pair difference.

15. A system according to claim 13, wherein said first data and said second data comprise data of a same modality.

16. A system according to claim 15, wherein said first data is different from said second data due to a difference in at least one of respective locations and characteristics of said first data acquisition device and said second data acquisition device.

17. A system according to claim 13, wherein said first data and said second data comprise mutually different modalities.

18. A system according to claim 17, wherein one of said first data and second data comprises camera data and another one of said first data and second data comprises radar data.

19. A system according to claim 13, wherein said human sensible output comprises a biometric output.

20. A method for automatically identifying elements in a scene, comprising:
obtaining first data relating to at least one first scene possibly including at least one element of interest;
obtaining second data different from said first data and relating to a second scene including said at least one element of interest;
processing, by a first neural network, at least some of said first data to automatically extract at least one first feature representing at least a part of said at least one first scene;
processing, by a second neural network, at least some of said second data to automatically extract at least one second feature representing said element of interest;
finding a difference between said at least one first feature and at least one second feature;
ascertaining whether or not said at least one element of interest is present in said at least one first scene, based on said difference; and
automatically providing feedback control to at least one related system based on said ascertaining.
